(19) United States
(12) Patent Application Publication
(10) Pub. No.: US 2008/0301907 A1
(43) Pub. Date: Dec. 11, 2008

(54) FLIP-OUT MECHANISM WITH SAFETY PRESS-BUTTON FOR A FOLDABLE DEVICE

(75) Inventor: YOUNG TONY CHUNLUNG, (US)

Correspondence Address: ERIC CHAN, 42 PIN OAKS DRIVE, PHOENIXVILLE, PA, 19460, US

(73) Assignee: CALTRACO INTERNATIONAL LIMITED, KOWLOON (HK)

(21) Appl. No.: 11/758,670

(22) Filed: Jun. 6, 2007

(51) Int. Cl. E05D 11/00

(52) U.S. Cl. 16/251; 16/308; 16/404

(57) ABSTRACT

A flip-out mechanism with safety press-button for a foldable device which comprises a torsion spring which is coiled uniformly or substantially uniformly with each coil of the same or substantially the same outside diameter and disposed in a circular compartment of the inner surface of the top casing, with one end of the torsion spring bended outward from the coil body of the torsion spring and disposed inside a corresponding receiving section of the circular compartment and with the other end of the torsion spring bended upward from the coil body of the torsion spring and disposed inside a receiving hole on the surface of the foldable object near its periphery aligned in a straight line with the through hole in the middle and then with the recess. The present invention is of simpler construction and assembly and is therefore susceptible of a lower production cost. It is also safer for carrying around.

### BACKGROUND OF THE INVENTION

The present invention relates to a flip-out mechanism and more particularly pertains to a flip-out mechanism with safety press-button for a foldable device such as a magnifier, a key ring, a pen, a pill box or a personal hanging ornament.

At present the flip-out mechanism is widely used in foldable knives, foldable nail files, foldable magnifiers, foldable key rings, and the like as the mechanism enables easy unfolding and/or folding of the foldable device by one hand. As foldable knives and other hand tools may cause personal injuries accidentally, the flip-out mechanism for such a foldable device is mainly of reliable and thus complicated construction with emphasis on the safety of the user. For other foldable devices such as magnifiers and key rings, the safety of the user is not an issue of uppermost concern. In general, they are required to be light and compact in size for ease of being carried around. Therefore, the flip-out mechanism for this kind of foldable devices is generally of simple construction. A conventional flip-out mechanism for a foldable device such as a foldable magnifier in the prior art comprises a pin, two springs and a press-button.

The body of the foldable device is generally divided into two halves which can be engaged together with a cavity formed inside for storing the foldable object when not in use and with an opening on one side from which the foldable object may flip out from the body of the foldable device for use. Therefore, the foldable device as a whole is compact in size while not in use. When the foldable object flips out and the foldable device is in an extended state, the body of the foldable device can serve as a handle for the user to hold the foldable device for ease of using the foldable object.

The pin of a conventional flip-out mechanism connects the foldable object with the body of the foldable device. The foldable object generally has a connecting part and an object part. For example, in a foldable magnifier, the object part is a magnifying lens. The connecting part of the foldable object has a through hole at the centre and the through hole can allow the pin to pass through. The body of the foldable device has a compartment on its each half and the two compartments engage together to form the cavity. On the inside surface of one of the compartments, there is a circular depression which corresponds to the connecting part of the foldable object in position. One end of the pin is fixed onto the inside surface at the center of the circular depression of the compartment. The pin passes through the through hole of the foldable object. The other end of the pin is removably fixed, by way of a screw for example, onto the inside surface of the other compartment in corresponding position. The pin therefore confines the foldable object inside the cavity and it forms an axis around which the foldable object rotates out from the opening of the body of the foldable device.

A conventional flip-out mechanism comprises a clock spring. The clock spring is made from flat stock and coiled like a snail shell with each coil nesting inside the next larger one. The clock spring is disposed in the circular depression of the compartment. The outer end of the clock spring is a bended leg which is fixed onto the inside wall of the body of the foldable device by means of a receiving space adjacent to and connected to the circular depression for holding and fixing the bended leg. The inner end of the clock spring is another bended leg in the same direction which is engaged with the connecting part of the foldable object by means of a notch on the surface of the connecting part facing the circular depression. The notch corresponds in size and shape with the bended leg of the inner end of the clock spring. The clock spring therefore exerts torsional force against the foldable object.

A conventional flip-out mechanism comprises a small compression spring. The compression spring is disposed inside a recess which is opened on the surface of the connecting part of the foldable object facing the circular depression. The recess is adjacent to the through hole and the notch of the connecting part. The front surface of the press-button of a conventional flip-out mechanism is disposed on the outside surface of the circular depression and the bottom surface of which is connected to the compression spring. The press-button in combination with the compression spring therefore functions a lock to release or retain the foldable object.

The operation of the conventional flip-out mechanism is explained as follows: While not in use, the foldable object is stored in the cavity formed by the two halves of the body of the foldable device. While in use, the user presses the press-button, and the compression spring becomes shorter. The foldable object is therefore unlocked. Owing to the release of the clock spring, the foldable object flips out from the opening of the body of the foldable device. The foldable device is thus in an extended state with the body as the handle for the user to use the foldable object by one hand. After finishing using the foldable device, the user can simply push the foldable object back into the opening of the body of the foldable device. While the foldable object rotates back into the opening, as the inner bended leg of the clock spring is engaged with the notch of the foldable object, as the notch rotates, the inner bended leg brings the clock spring to twist until the compression spring of the foldable object reaches the bottom surface of the press-button and it is locked in that position. In that position, the foldable object is totally stored inside the cavity of the body of the foldable device ready for next use. The foldable device is therefore compact in size and is portable. Its operation is simple and convenient.

However, at a manufacturing level, the production cost of such conventional flip-out mechanism is generally high. First, the clock spring is made of stainless steel as it will not rust. Further, as the clock spring is made from flat stock and it is hard to mount the clock spring in the circular depression with one end fixed onto the inside wall of the body of the foldable device and the other end engaged with the notch of the foldable object. The assembling process has to be done by hand and it requires substantial strength to accomplish the task.

Further, the press-button is not of secure construction. The press-button may be accidentally pressed, thereby causing the abrupt unfolding of the foldable object and the possible property or even personal injuries arising therefrom. If the object is a sharp tool, the injuries may be very serious. At the least, the inadvertent unfolding of the foldable object is likely to reduce the durability of the foldable object itself. In the know art, there is a replacement of the press-button by the push-button. However, the push-button is of more complicated and thus more costly construction.

### BRIEF SUMMARY OF THE INVENTION

In view of the aforesaid disadvantages now present in the prior art, the object of the present invention is to provide a flip-out mechanism with safety press-button for a foldable device which is of simpler construction and assembly and is therefore susceptible of a lower production cost.

Another object of the present invention is to provide a flip-out mechanism with safety press-button for a foldable device which is safer for carrying around.

To attain this, the present invention generally comprises a pin for positioning a foldable object inside a casing of a foldable device by passing through a through hole of the foldable object and forming an axis around which the foldable object rotates, wherein the casing is composed of a top casing and a bottom casing which are engaged together with a cavity formed inside in which the foldable object is disposed when not in use and with an opening formed on one side from which the foldable object rotates out for use; a compression spring which is disposed inside a recess on one surface of the foldable object for locking the foldable object; and a press-button which is disposed with its front surface on the outside surface of the top casing and its bottom surface connected to the compression spring for releasing the locking of the foldable object; which is characterized in that it also comprises a torsion spring which is coiled uniformly or substantially uniformly with each coil of the same or substantially the same outside diameter and disposed in a circular compartment of the inner surface of the top casing, with one end of the torsion spring bended outward from the coil body of the torsion spring and disposed inside a corresponding receiving section of the circular compartment and with the other end of the torsion spring bended upward from the coil body of the torsion spring and disposed inside a receiving hole on the surface of the foldable object near its periphery aligned in a straight line with the through hole in the middle and then with the recess.

The top casing is provided with an aperture through which the bottom surface of the press-button connects to the compression spring; and when the compression spring is released, a first end of the compression spring extends into the aperture and so the foldable object is locked; and when the compression spring is compressed by the bottom surface of the press-button, the first end of the compression spring detaches from the aperture and so the foldable object is unlocked.

The recess is adjacent to the through hole of the foldable object.

The circular compartment has a trough in the shape of a semi-circle as a path for the compression spring to move along when the foldable object rotates; the trough extends from the bottom surface of the press-button and extends around the pin up to 180° or substantially 180°, thereby allowing the smooth rotation of the foldable object and increasing the stopping effect when the foldable object is fully rotated out.

The torsion spring has at least two complete coils. That is, the wire forming the torsion spring goes completely around at least twice.

The angle between the outward bending end and the upward bending end of the torsion spring is preferably 60° or 50°. The angle between the outward bending end and the upward bending end of the torsion spring is preferably within the range of 30° to 80°.

The torsion spring is made of small wire from oil tempered wire.

The present invention also comprises a button bezel of convex construction which surrounds the press-button and is of height higher than that of the press-button, thereby preventing the press-button from being accidentally pressed.

The present invention also comprises a press-button compression spring which is disposed in between the press-button and the outside surface of the top casing. The press-button compression spring returns the press-button to its original position after pressing.

The bottom surface of the press-button can be in the form of a peg which engages with the compression spring in the recess of the foldable object.

The compression spring in the recess of the foldable object can be completely covered by a slidable cap which can slide along the trough of the circular compartment of the inner surface of the top casing, thereby preventing the compression spring from being displaced.

The operation of the flip-out mechanism of the present invention is explained as follows: While not in use, the foldable object is stored in the cavity formed by the top casing and the bottom casing of the foldable device. While in use, the user presses the press-button, the bottom surface or the peg of the press-button is then lowered and presses the compression spring, through the slidable cap if there is one, and the compression spring becomes shorter. The press-button will immediately returns to its original position due to the force of the press-button compression spring if there is one. As the compression spring, with the slidable cap if there is one, becomes shorter and detaches from the aperture of the top casing, the foldable object is therefore unlocked. Owing to the release of the torsion spring, the foldable object flips out from the opening of the foldable device. The foldable device is thus in an extended state with the casing as the handle for the user to use the foldable object by one hand. After finishing using the foldable device, the user can simply push the foldable object back into the opening of the foldable device. While the foldable object rotates back into the opening, as the upward bended end of the torsion spring is engaged with the receiving hole of the foldable object, as the foldable object rotates, the upward bended end brings the torsion spring to twist until the compression spring of the foldable object, with the slidable cap if there is one, reaches and extends into the aperture of the top casing and engages with the bottom surface or the peg of the press-button and locked in that position. In that position, the foldable object is totally stored inside the cavity of the foldable device ready for next use. The foldable device is therefore compact in size and is portable. Its operation is simple and convenient.

In comparison with the prior art, the present invention has the following advantages and effects:

First, unlike the clock spring made of flat stock of stainless steel, since the torsion spring can be made of small wire from oil tempered wire having as low as two complete coils, it consumes less material and can use less costly material. Further, it is easier to install the torsion spring and requires less physical strength to accomplish the assembling process.

Secondly, since the present invention introduces a button bezel which is of simple and secure construction, the press-button can be prevented from being accidentally pressed, thereby effectively avoiding the abrupt unfolding of the foldable object and the possible property or even personal injury arising therefrom and increasing the durability of the foldable object itself.

### BRIEF DESCRIPTION OF THE DRAWINGS

FIG. 1 shows an exploded view of an embodiment of the present invention.

FIG. 2 shows another exploded view of the embodiment.

FIG. 3 shows the front view of the embodiment in an extended state for use.

FIG. 4 shows the front view of the embodiment while not in use.

### DETAILED DESCRIPTION OF THE INVENTION

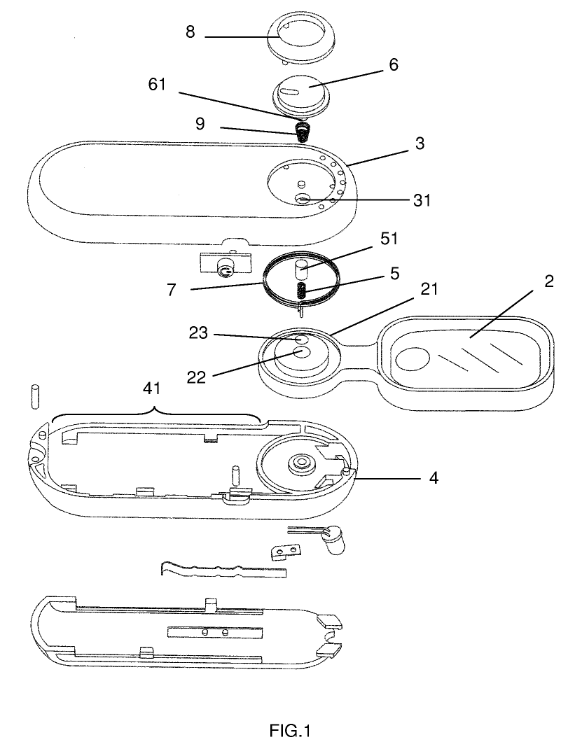

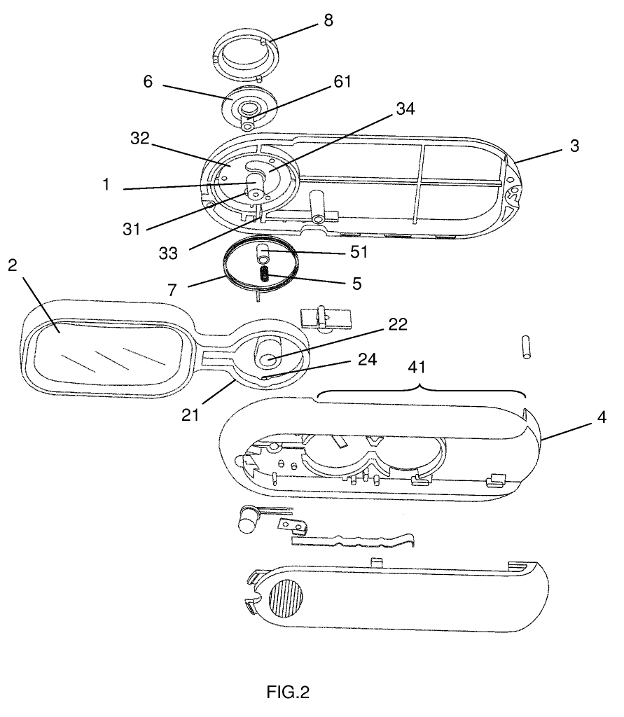

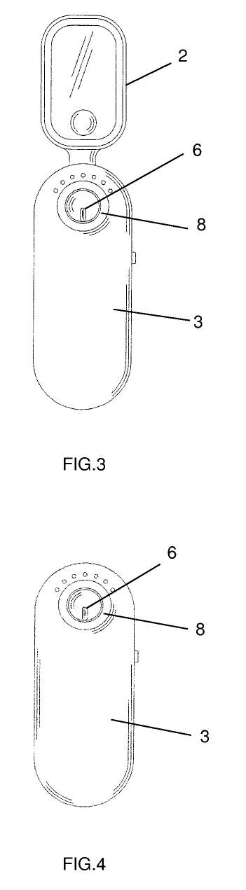

The present invention is further described in detail with the following embodiment and the accompanying drawings. FIGS. 1 to 4 illustrate an embodiment of the present invention, which is a flip-out mechanism with safety press-button for a portable foldable magnifier. It comprises a pin 1 for positioning a foldable magnifying lens 2 inside a casing of a foldable magnifier by passing through a through hole 22 of the body 21 of the foldable magnifying lens 2 and forming an axis around which the foldable magnifying lens 2 rotates, wherein the casing is composed of a top casing 3 and a bottom casing 4 which are engaged together with a cavity formed inside in which the foldable magnifying lens 2 is disposed when not in use and with an opening 41 formed on one side from which the foldable magnifying lens 2 rotates out for use.

A compression spring 5 is disposed inside a recess 23 on one surface of the body 21 of the foldable magnifying lens 2 for locking the foldable magnifying lens 2. The recess 23 is adjacent to the through hole 22 of the body 21 of the foldable magnifying lens 2. In this embodiment, the compression spring 5 in the recess 23 of the foldable magnifying lens 2 is completely covered by a slidable cap 51.

A press-button 6 is disposed with its front surface on the outside surface of the top casing 3 and a peg 61 on its bottom surface. The top casing 3 is provided with an aperture 31 through which the peg 61 of the press-button 6 connects to the slidable cap 51 of the compression spring 5. When the compression spring 5 is released, the slidable cap 51 of the compression spring 5 extends into the aperture 31 and so the foldable magnifying lens 2 is locked. When the compression spring 5 is compressed by the peg 61 of the press-button 6, the slidable cap 51 of the compression spring 5 detaches from the aperture 31 and so the foldable magnifying lens 2 is unlocked.

A torsion spring 7 is coiled uniformly or substantially uniformly with each coil of the same or substantially the same outside diameter and disposed in a circular compartment 32 of the inner surface of the top casing 3, with one end of the torsion spring 7 bended outward from the coil body of the torsion spring 7 and disposed inside a corresponding receiving section 33 of the circular compartment 32 and with the other end of the torsion spring 7 bended upward from the coil body of the torsion spring 7 and disposed inside a receiving hole 24 on the surface of the body 21 of the foldable magnifying lens 2 near its periphery aligned in a straight line with the through hole 22 in the middle and then with the recess 23. The torsion spring 7 has two complete coils. That is, the wire forming the torsion spring 7 goes completely around twice. The angle between the outward bending end and the upward bending end of the torsion spring 7 is 50°. In other embodiments, the angle can be 60° or any figure falling within the range of 30° to 80°. In this embodiment, the torsion spring 7 is made of small wire from oil tempered wire.

The circular compartment 32 has a trough 34 in the shape of a semi-circle as a path for the slidable cap 51 of the compression spring 5 to move along when the foldable magnifying lens 2 rotates. The provision of the slidable cap 51 prevents the compression spring 5 from being displaced. The trough 34 extends from the bottom surface of the press-button 6 and extends around the pin 1 up to 180° or substantially 180°, thereby allowing the smooth rotation of the foldable magnifying lens 2 and increasing the stopping effect when the foldable magnifying lens 2 is fully rotated out.

A button bezel 8 of convex construction surrounds the press-button 6 and is of height higher than that of the press-button 6, thereby preventing the press-button 6 from being accidentally pressed.

A press-button compression spring 9 is disposed in between the press-button 6 and the outside surface of the top casing 3. The press-button compression spring 9 returns the press-button 6 to its original position after pressing.

When the foldable magnifier is not in use, the foldable magnifying lens 2 is stored in the cavity formed by the top casing 3 and the bottom casing 4 of the foldable magnifier. While in use, the user presses the press-button 6, the peg 61 on the bottom surface of the press-button 6 is then lowered and presses the compression spring 5 through the slidable cap 51 and the compression spring 5 and the slidable cap 51 detach from the aperture 31 of the top casing 3. The press-button 6 will immediately returns to its original position due to the force of the press-button compression spring 9. As the compression spring 5 with the slidable cap 51 detach from the aperture 31 of the top casing 3, the foldable magnifying lens 2 is therefore unlocked. Owing to the release of the torsion spring 7, the foldable magnifying lens 2 flips out from the opening 41 of the foldable magnifier. The foldable magnifier is thus in an extended state with the casing as the handle for the user to use the foldable magnifying lens 2 by one hand.

After finishing using the foldable magnifier, the user can simply push the foldable magnifying lens 2 back into the opening 41 of the foldable magnifier. While the foldable magnifying lens 2 rotates back into the opening 41, as the upward bended end of the torsion spring 7 is engaged with the receiving hole 24 of the foldable magnifying lens 2, as the foldable magnifying lens 2 rotates, the upward bended end brings the torsion spring 7 to twist until the compression spring 5 and the slidable cap 51 of the foldable magnifying lens 2 reach and extend into the aperture 31 of the top casing 3 and engage with the peg 61 on the bottom surface of the press-button 6 and it is locked in that position. In that position, the foldable magnifying lens 2 is totally stored inside the cavity of the foldable magnifier ready for next use. The foldable magnifier is therefore compact in size and is portable. Its operation is simple and convenient.

In this embodiment, a circuit for a LED driven by dry batteries is installed. The present invention is capable of incorporating with various add-ons to increase the functions of the foldable device.

The present invention is also capable of various embodiments such as a key ring, a pen, a pill box or a personal hanging ornament herein not specifically illustrated.

As to a further discussion of the manner of usage and operation of the present invention, the same should be apparent from the above description. Accordingly, no further discussion relating to the manner of usage and operation is provided.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

The present invention is capable of other embodiments and of being practiced and carried out in various ways. It is to be understood that the phraseology and terminology employed herein are for the purpose of description and should not be regarded as limiting.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to falling within the scope of the invention.

What is claimed is:

1. A flip-out mechanism with safety press-button for a foldable device comprising a pin for positioning a foldable object inside a casing of a foldable device by passing through a through hole of the foldable object and forming an axis around which the foldable object rotates, wherein the casing is composed of a top casing and a bottom casing which are engaged together with a cavity formed inside in which the foldable object is disposed when not in use and with an opening formed on one side from which the foldable object rotates out for use; a compression spring which is disposed inside a recess on one surface of the foldable object for locking the foldable object; and a press-button which is disposed with its front surface on the outside surface of the top casing and its bottom surface connected to the compression spring for releasing the locking of the foldable object; which is characterized in that it also comprises a torsion spring which is coiled uniformly or substantially uniformly with each coil of the same or substantially the same outside diameter and disposed in a circular compartment of the inner surface of the top casing, with one end of the torsion spring bended outward from the coil body of the torsion spring and disposed inside a corresponding receiving section of the circular compartment and with the other end of the torsion spring bended upward from the coil body of the torsion spring and disposed inside a receiving hole on the surface of the foldable object near its periphery aligned in a straight line with the through hole in the middle and then with the recess.

2. The flip-out mechanism with safety press-button for a foldable device as in claim 1, wherein the top casing is provided with an aperture through which the bottom surface of the press-button connects to the compression spring; and when the compression spring is released, a first end of the compression spring extends into the aperture and so the foldable object is locked; and when the compression spring is compressed by the bottom surface of the press-button, the first end of the compression spring detaches from the aperture and so the foldable object is unlocked.

3. The flip-out mechanism with safety press-button for a foldable device as in claim 1, wherein the recess is adjacent to the through hole of the foldable object.

4. The flip-out mechanism with safety press-button for a foldable device as in claim 1, wherein the circular compartment has a trough in the shape of a semi-circle as a path for the compression spring to move along when the foldable object rotates; the trough extends from the bottom surface of the press-button and extends around the pin up to 180° or substantially 180°, thereby allowing the smooth rotation of the foldable object and increasing the stopping effect when the foldable object is fully rotated out.

5. The flip-out mechanism with safety press-button for a foldable device as in claim 1, wherein the torsion spring has at least two complete coils.

6. The flip-out mechanism with safety press-button for a foldable device as in claim 1, wherein the angle between the outward bending end and the upward bending end of the torsion spring is preferably 60° or 50°. The angle between the outward bending end and the upward bending end of the torsion spring is preferably within the range of 30° to 80°.

7. The flip-out mechanism with safety press-button for a foldable device as in claim 1, wherein the torsion spring is made of small wire from oil tempered wire.

8. The flip-out mechanism with safety press-button for a foldable device as in claim 1, wherein it also comprises a button bezel of convex construction which surrounds the press-button and is of height higher than that of the press-button, thereby preventing the press-button from being accidentally pressed.

9. The flip-out mechanism with safety press-button for a foldable device as in claim 1, wherein it also comprises a press-button compression spring which is disposed in between the press-button and the outside surface of the top casing, and the press-button compression spring returns the press-button to its original position after pressing.

10. The flip-out mechanism with safety press-button for a foldable device as in claim 1, wherein the bottom surface of the press-button is in the form of a peg which engages with the compression spring in the recess of the foldable object.

11. The flip-out mechanism with safety press-button for a foldable device as in claim 1, wherein the compression spring in the recess of the foldable object is completely covered by a slidable cap which can slide along the inner surface of the top casing, thereby preventing the compression spring from being displaced.

12. The flip-out mechanism with safety press-button for a foldable device as in claim 4, wherein the compression spring is completely covered by a slidable cap which can slide along trough of the circular compartment, thereby preventing the compression spring from being displaced.
